(19) United States
(12) Patent Application Publication
(10) Pub. No.: US 2008/0142140 A1
(43) Pub. Date: Jun. 19, 2008

(54) Method and apparatus for building a puncture sealant tire

(76) Inventors: Patrick David Marks, Uniontown, OH (US); Thomas Roy Fuhrig, North Canton, OH (US); Joseph Alan Incavo, Hudson, OH (US); James Earl Koerner, Uniontown, OH (US); Terrence Lee Parsons, North Canton, OH (US); Charles Kenneth Schmalix, Canal Fulton, OH (US); Paul Keyser Blackiston, Massillon, OH (US); Warren James Busch, North Canton, OH (US); Timothy Patrick Lovell, Uniontown, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/639,721

(22) Filed: Dec. 15, 2006

(51) Int. Cl. B29C 73/16

(52) U.S. Cl. 152/505; 156/115

(57) ABSTRACT

A method and apparatus for making a tire with a built in sealant is provided. The method includes the steps of mounting an inner liner onto a tire building drum, extruding a sealant composition into strips having tapered sidewalls, cutting the strip to a desired length, mounting the sealant over the inner liner in two or more zones, wherein each zone is separated by a circumferential divider which joins the inner liner to the a cover layer forming a barrier to prevent migration of the sealant from one zone to another.

### TECHNICAL FIELD

This invention relates to a method and apparatus for making and applying a puncture sealant to tire components mounted upon a tire building drum.

### BACKGROUND OF THE INVENTION

It is known in the prior art to apply puncture sealants made of puncture sealing rubber or plastic material on the crown portion of the tire so that when a sharp object such as a nail pierces the tire, the tire sealant forms a seal around the puncture. Tire sealants of this nature tend to flow or be soft resulting in a tendency to migrate towards the center portion of the tire due to centrifugal force as the tire is rotated at high speeds. Thus the outer portions of the crown have reduced sealant volume due to migration of the sealant towards the center. It is known in the prior art to compartmentalize a sealant into multiple cells such as shown in U.S. Pat. No. 2,877,819 or U.S. Pat. No. 4,388,261. One disadvantage to compartmentalizing the sealant into multiple cells is that the manufacturing process is costly. Further, having too many compartments may impede the effective flow of the sealant needed to seal a puncture. Further, using an extruder to manufacture the sealant into compartments is costly and requires additional manufacturing steps. Thus it is desired to provide a tire and a low cost manufacturing method for providing puncture sealant in a tire which does not migrate during use.

### Definitions

“Aspect Ratio” means the ratio of a tire's section height to its section width.

“Axial” and “axially” mean the lines or directions that are parallel to the axis of rotation of the tire.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Skive” or “skive angle” refers to the cutting angle of a knife with respect to the material being cut; the skive angle is measured with respect to the plane of the flat material being cut.

“Laminate structure” means an unvulcanized structure made of one or more layers of tire or elastomer components such as the innerliner, sidewalls, and optional ply layer.

### BRIEF DESCRIPTION OF THE DRAWINGS

The structure, operation, and advantage of the invention will become further apparent upon consideration of the following description taken in conjunction with the accompanying drawings wherein:

FIG. 1 is a schematic view of a cross section of tire with sealant;

FIG. 2 is a schematic view of a cross section of the sealant, barrier and innerliner layers shown on the tire building drum;

FIG. 3 is a schematic view of an alternate embodiment of the cross section of the sealant, barrier and innerliner layers shown on the tire building drum.

### DETAILED DESCRIPTION OF THE INVENTION

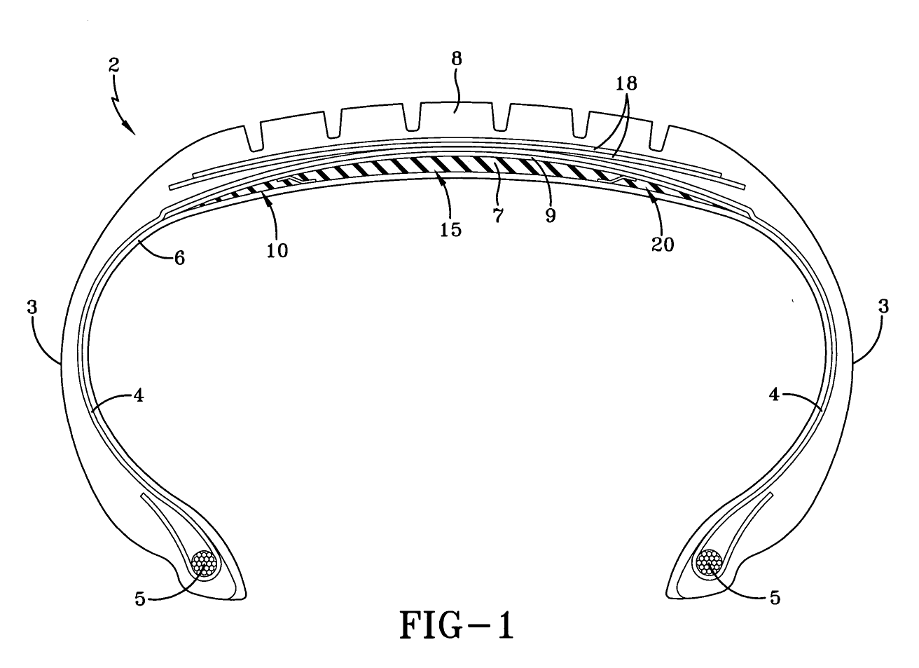

Referring now to FIG. 1, there is illustrated a cross-sectional view of a self-sealing pneumatic tire constructed in accordance with the invention. The tire may be any type of tire. For example, a truck tire, a light truck tire or a passenger tire. The tire 2 includes sidewalls 3, a supporting tire carcass 4, a pair of beads 5, an inner liner 6, a layer of sealant 7, a cover layer 9 and an outer circumferential tread 8. The sidewalls 3 extend radially inward from the axial outer edges of the tread portion 8 to join the respective beads. The carcass 4 acts as a support structure for the tread and sidewalls, and is comprised of one or more layers of ply. Sealant layer 7 is shown disposed between the inner liner 6 and an elastomer cover layer 9 such as for example, a rubber layer, a ply layer or an optional barrier layer. The cover layer 9 may have a width sized to cover the sealant layer such as from shoulder to shoulder, or may further extend down into the bead area between the ply and innerliner. The sealant layer 7 may also be disposed at different locations as described in more detail, below. The tread region 8 forms a crown region of the carcass. In the interior region of the tread, there is generally found one or more belts 18. The surface region of the tread forms a tread pattern.

### Sealant Composition

The sealant 7 may comprise any suitable sealant composition known to those skilled in the art, such as rubber or elastomer compositions and plastic compositions. One suitable polymer composition suitable for use is described in U.S. Pat. No. 4,895,610, the entirety of which is incorporated by reference. The polymer compositions described therein include the following composition by weight: 100 parts of a butyl rubber copolymer, about 10 to about 40 parts of carbon black, about 5 to about 35 parts of an oil extender, and from about 1 to 8 parts of a peroxide vulcanizing agent. A second polymer composition includes the following composition by weight: 100 parts of a butyl rubber copolymer, about 20 to about 30 parts of carbon black, about 8 to about 12 parts of an oil extender, and from about 2 to 4 parts of a peroxide vulcanizing agent.

The sealant 7 may also comprise a colored polymer composition as described in U.S. Pat. No. 7,073,550, the entirety of which is incorporated herein by reference. The colored polymer composition is comprised of, based upon parts by weight per 100 parts by weight of said partially depolymerized butyl rubber exclusive of carbon black:
(A) a partially organoperoxide-depolymerized butyl rubber as a copolymer of isobutylene and isoprene, wherein said butyl rubber, prior to such depolymerization, is comprised of about 0.5 to about 5, preferably within a range of from 0.5 to one, percent units derived from isoprene, and correspondingly from about 95 to about 99.5, preferably within a range of from 99 to 99.5, weight percent units derived from isobutylene;
(B) particulate reinforcing filler comprised of:
   (1) about 20 to about 50 phr of synthetic amorphous silica, preferably precipitated silica, or
   (2) about 15 to about 30 phr synthetic amorphous silica, preferably precipitated silica, and about 5 to about 20 phr of clay, preferably kaolin clay, or
   (3) about 15 to about 30 phr synthetic amorphous silica, preferably precipitated silica, and about 5 to about 20 phr of calcium carbonate,
   (4) about 15 to about 30 phr synthetic amorphous silica, preferably precipitated silica, about 5 to about 15 phr of clay, preferably kaolin clay, and about 5 to about 15 phr of calcium carbonate;
(C) from zero to 6, alternately about 0.5 to about 5, phr of short organic fibers
(D) a colorant of other than a black color wherein said colorant is selected from at least one of organic pigments, inorganic pigments and dyes, preferably from organic pigments and inorganic pigments;
(E) from zero to about 20, alternately about 2 to about 15, phr of rubber processing oil, preferably a rubber processing oil having a maximum aromatic content of about 15 weight percent, and preferably a naphthenic content in a range of from about 35 to about 45 weight percent and preferably a paraffinic content in a range of about 45 to about 55 weight percent.

Another sealant polymer composition which may be utilized by the invention is described in U.S. Pat. No. 6,837,287, the entirety of which is hereby incorporated by reference.

Further, any sealant polymer composition may also be used with the invention that has a polymer composition of butyl rubber and an organoperoxide vulcanizing agent which becomes activated at high temperatures above 100 deg C.

### Tire Configuration with Sealant

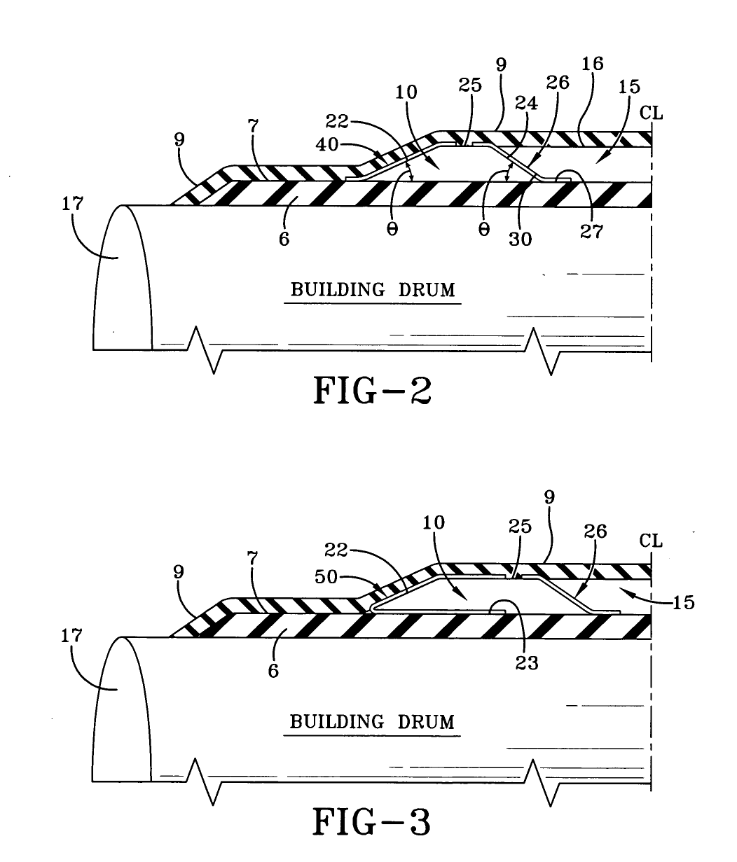

FIG. 1 illustrates one example of a sealant configuration for a tire. The sealant is comprised of two or more zones, preferably two or more axially outer zones 10, 20 located between the shoulder portion and the center portion of the tire and one or more axially inner zones 15 located in the center portion of the tire. As shown in FIG. 2, the sealant in the axially outer zones 10, 20 is first applied to the tire building drum directly over the tire inner liner 6 and then spliced together. The sealant in each of the axially outer zone preferably has an axially outer end 22 and an axially inner end 24. The outer and inner ends 22, 24 may be angled at an angle θ in the range of about 10 degrees to about 90 degrees, more preferably in the range of about 30 to about 60 degrees. Thus the sealant in the axially outer zones may have a trapezoidal cross-section or any desired cross-sectional shape. The sealant width may be in the range of about 3 to 6 inches.

The sealant 7 may be applied directly to a tire component mounted on the tire building drum using a gear pump extruder. The gear pump extruder may have a shaping die to extrude the sealant in a continuous strip onto the rotating tire drum. The strip is spirally wound onto the tire building drum wherein the edge of each strip abuts with an adjacent strip. The sealant may also be extruded to a desired shape and then applied to the tire building drum using a machine applier or by hand.

Next, a strip of elastomer, gum strip of rubber, fabric, dipped fabric, or any other suitable material known to those skilled in the art (hereinafter, “divider strip”) is applied over the axially inner end 24. The divider strip 26 has a sufficient width to extend from the top surface 25 of the sealant outer zone 10, along the entire angled end 24 and then directly onto a portion of the tire liner 27. The width of the divider strip may range from about 0.5 to about 3 inches, depending upon the thickness of the sealant. The thickness of the strip may be, for example, about 0.05 to 0.1 inches. The divider strip is applied circumferentially around the entire axially inner end 24 and then spliced together, in order to form a barrier between the axially outer zones and the axially inner zone(s). The divider strip may be applied manually or by machine, such as by a gear pump extruder.

Next one or more axially inner zones 15 of the sealant are applied to the tire building drum. The axially inner zone(s) 15 has a first and second surface 30 for mating with the respective divider strip 26. The first and second surfaces 30 are preferably shaped at the same angular inclination as the abutting surfaces 24. The axially outer zones 10, 20 and the one or more inner zones 15 and the two or more divider strips 26 are closely spaced in an abutting relationship.

A cover layer 9 is applied directly over the liner, the sealant axially outer angled end 22 and the upper surface 25 of the axially outer zones 10, 20 and over the upper surface 16 of the sealant in the one or more axially inner zones 15. In particular, the liner, divider strip 26 and the barrier layer 9 upon vulcanization, form a dam or barrier to prevent the built in sealant from migrating towards the centerline during tire operation.

An optional shoulder divider strip 40 may also be applied to the axially outer surface 22 of the axially outer zones 10, 20. The divider strip together with the liner 6 and barrier 40 prevent migration of the sealant into the shoulder area of the tire.

Alternatively, as shown in FIG. 3, a square woven mesh fabric 50 may be applied along a portion of the top surface 25, outer end surface 22 and optionally wrap around a portion of bottom surface 23 of the axially outer zone 10, 20. The woven mesh fabric 50 is designed to hold the sealant in the shoulder area and prevention migration to the centerline of the tire.

The thickness of the sealant in each of the zones 10, 15, 20 can vary greatly in an unvulcanized puncture sealant-containing tire. Generally, the thickness of the sealant composition layer may range from about 0.13 cm (0.05 inches) to about 1.9 cm (0.75 inches). In passenger and truck tires it is normally desired for the sealant composition layer to have a thickness of about 0.32 cm (0.125 inches).

After the unvulcanized pneumatic rubber tires of this invention are assembled they are vulcanized using a normal tire cure cycle. The tires of this invention can be cured over a wide temperature range depending somewhat upon the size of the tire and the degree of desired depolymerization of the butyl rubber as well as the thickness of the sealant layer itself) and sufficient to at least partially depolymerize said sealant precursor layer to the aforesaid storage modulus (G′) physical property.

While certain representative embodiments and details have been shown for the purpose of illustrating the invention, it will be appreciated there is still in the art various changes and modifications may be made therein without departing from the spirit or scope of the invention.

What is claimed is:

1. A method of making a tire with a built in sealant comprising the steps of:
mounting an inner liner onto a tire building drum, placing two sealant axially outer zones onto the inner liner; each axially outer zone of sealant having an axially outer surface, and an upper surface, laying a circumferential divider strip along a portion of the upper surface and along the axially outer surface of the sealant axially outer zone, and wherein the divider strip further extends onto the inner liner, placing a sealant axially inner zone between the axially outer zones and into abutment with the divider strips, applying a barrier layer having a suitable width to extend from shoulder to shoulder, wherein the divider strips form a barrier with said barrier layer and inner liner upon vulcanization of said tire.

2. The method of claim 1 wherein the sealant axially outer zones have angled outer walls, and angled inner walls, wherein the sealant axially inner zone has mating outer walls for adjoining to the angled inner walls of said sealant axially outer zones.

3. The method of claim 1 wherein the sealant has a width in the range of about 6 to about 10 inches.

4. The method of claim 1 wherein the sealant is colored.

5. The method of claim 1 wherein the sealant is comprised of, based upon parts by weight per 100 parts by weight of said partially depolymerized butyl rubber exclusive of carbon black:
(A) a partially organoperoxide-depolymerized butyl rubber as a copolymer of isobutylene and isoprene, wherein said butyl rubber, prior to such depolymerization, is comprised of about 0.5 to about 5 percent units derived from isoprene, and correspondingly from about 95 to about 99.5 weight percent units derived from isobutylene;
(B) particulate reinforcing filler comprised of:
(1) about 20 to about 50 phr of synthetic amorphous silica, or
(2) about 15 to about 30 phr synthetic amorphous silica, preferably precipitated silica, and about 5 to about 20 phr of clay, or
(3) about 15 to about 30 phr synthetic amorphous silica and about 5 to about 20 phr of calcium carbonate, or
(4) about 15 to about 30 phr synthetic amorphous silica, about 5 to about 15 phr of clay and about 5 to about 15 phr of calcium carbonate;
(C) from zero to 6 phr of short organic fibers;
(D) a colorant of other than a black color wherein said colorant is selected from at least one of organic pigments, inorganic pigments and dyes; and
(F) from zero to about 20 phr of rubber processing oil.

6. A tire with a built in sealant comprising: sidewalls, a supporting tire carcass comprised of one or more layers of ply, a pair of beads, an inner liner, and an outer circumferential tread, wherein the sidewalls extend radially inward from the axial outer edges of the tread portion to join the respective beads, and a layer of sealant disposed between the inner liner and the barrier layer, wherein the sealant includes first and second zones, wherein each zone of sealant has an axially inner surface and an upper surface, wherein a circumferential divider strip is positioned between the first zone and the second zone, and wherein the divider strip has a first end joined to the barrier layer and a second end joined with the inner liner.

7. The tire of claim 6 wherein there are two or more axially inner zones and a circumferential divider strip positioned therebetween and wherein the divider strip has a first end joined to the barrier layer and a second end joined with the inner liner.

8. The tire of claim 6 wherein the axially inner surface of said axially inner zone is angled in the range of about 20 to about 70 degrees.

9. The tire of claim 6 wherein the circumferential divider strip is positioned in the range of about 1 to about 6 inches from the centerline.

10. The tire of claim 6 wherein the axially outer sealant zone has an axially outer surface and wherein a circumferential divider is positioned adjacent to said axially outer surface.

11. A tire with a built in sealant comprising: sidewalls, a supporting tire carcass comprised of one or more layers of ply, a pair of beads, an inner liner, and an outer circumferential tread, wherein the sidewalls extend radially inward from the axial outer edges of the tread portion to join the respective beads, and a layer of sealant disposed between the inner liner and a cover layer, wherein the sealant includes first and second zones, wherein each zone of sealant has an axially inner surface and an upper surface, wherein a circumferential divider strip is positioned between the first zone and the second zone, and wherein the divider strip has a first end joined to the cover layer and a second end joined with the inner liner.

12. The tire of claim 11 wherein the cover layer is comprised of ply.

13. The tire of claim 11 wherein the cover layer is comprised of rubber.

14. The tire of claim 11 wherein the cover layer is a barrier layer which extends from bead to bead.
